(19) United States
(12) Patent Application Publication
(10) Pub. No.: US 2023/0157337 A1
(43) Pub. Date: May 25, 2023

(54) METHOD OF FLAVOR PROTECTION IN HERBS AND SPICES AND PRODUCTS THEREOF

(71) Applicant: ELLA FOODS PRIVATE LIMITED, Karnataka (IN)

(72) Inventors: Krishna Murthy Ella, Karnataka (IN); Ravi Bhuvanesh Kankanallu, Karnataka (IN); Shankaranarayana Ravi Kankanallu, Karnataka (IN); Narendra Babu Malleshaiah, Karnataka (IN)

(21) Appl. No.: 17/919,339

(22) PCT Filed: Mar. 3, 2021
(86) PCT No.: PCT/IN2021/050202

§ 371 Date: Oct. 17, 2022

(30) Foreign Application Priority Data
Apr. 16, 2020 (IN) 202041016515

(51) Int. Cl. A23L 27/14; A23L 3/26; A23L 5/30

(52) U.S. Cl. CPC A23L 27/14; A23L 3/263; A23L 5/36; A23L 3/375

(57) ABSTRACT

A method for preparing microbial contamination free spices and food products is provided. The invention relates to method for preparing cryogenic grinded and cold pasteurized (gamma irradiated) spices and spice related products which retains essential oils, aroma taste and color of the products and is free of any microbial contamination. The invention also relates to such microbial contamination free food products and spices thereof.

### CROSS-REFERENCE TO RELATED APPLICATIONS

This application claims priority to PCT Application No. PCT/IN2021/050202, having a filing date of Mar. 3, 2021, which is based on IN 202041016515, having a filing date of Apr. 16, 2020, the entire contents both of which are hereby incorporated by reference.

### FIELD OF TECHNOLOGY

The following relates to a method for preparing microbial contamination free spices and food products. More particularly, the following relates to method for preparing cryogenic grinded and cold pasteurized (gamma irradiated) spices and spice related products which retains essential oils, aroma taste, color and chemical compounds of the products and is free of any microbial contamination. The following also relates to such microbial contamination free food products and spices thereof.

### BACKGROUND

Prevention of food spoilage becomes particularly important to deliver safe and healthy products. There are many methods developed to prevent food spoilage. The traditional methods of preservation, such as drying, smoking and salting have been supplemented with pasteurization (by heat), canning (commercial sterilization by heat), refrigeration, freezing and chemical preservatives. However, these traditional methods have shown certain disadvantages. Chemical treatment leaves cancer causing chemical residues and also pre-packed food cannot be treated. Freezing method has not been found suitable for certain food materials including spices and also 5 has been found to be expensive. Drying and smoking cannot meet the hygienic requirements and will also change texture, color and flavor of the food. The use of steam has also been found to be disadvantageous as the packages have to be opened and food material is likely to absorb moisture.

Food irradiation is another technology that has been used to prevent food spoilage. Irradiation has been extensively used in the medical field for sterilizing instruments, dressings etc. Food irradiation is the process of exposing food to a carefully controlled amount of energy in the form of high-speed particles or rays. The purpose of food irradiation is to improve the quality of the food being irradiated, either from a microbiological, physical, or organoleptic perspective. This technology can also be called as cold pasteurization since gamma irradiation can kill many disease-causing bacteria (like E. coli, Listeria spp, Salmonella spp etc) without causing any heat in the food stuff. This is the most modern, scientific & safest technology to date to make spices and allied food stuffs free from bacterial contamination, mold, mycotoxins and other pollutants, insect infestation etc. As a result of significant reduction in the total number of bacteria in a food will result in an increase in the shelf life of the food.

The U.S. Pat. No. 6,868,136 discloses an irradiation apparatus particularly well suited to the irradiation of food at or near the point of consumption and includes an irradiation chamber, one or more ionizing radiation sources such as x-ray tubes, and a rotating food support.

The US Patent Publication No. 20030039726 discloses a method of treating a food product which includes packaging the food product in a modified atmosphere, removing oxygen from the modified atmosphere and irradiating the food product, such that the oxidation of the food product is impeded for a predetermined period of time after irradiating the food product.

The US Patent Publication No. 20030091708 discloses a method of irradiating food, comprising: grinding the food in an environment having an oxygen level lower than the oxygen level of air, irradiating the food in an environment having an oxygen level lower than the oxygen level of air, and packaging the food in a package in an environment having an oxygen level lower than the oxygen level of air.

The Indian Patent Application No. 8491/DELNP/2014 discloses a food sterilization and preservation method comprising a water vapor plasma irradiation step of irradiating a food with water vapor plasma and a step of applying a calcined powder of a natural calcium-rich material to the food which has undergone the water vapor plasma irradiation step.

The Indian Patent Application No. 5/CHE/2013 discloses a method of processing edible food products to retain the natural aroma, flavor, prevention from biological degradation, microbial contamination and protection from re-infestation of the food product. The method comprises filling the food product in a three-layered packaging system consisting of low density polyethylene layer as the innermost layer followed by aluminum layer and then biaxially oriented polyester layer; flushing nitrogen in the filled food product to remove the oxygen; subjecting the food product to gamma irradiation and hermetically sealing the package. The food product in the above disclosed method is selected from the group comprising spices, condiments, infant food, baby and weaning food and any agricultural product.

The Indian Patent Application No. 441/DEL/2001 (granted as IN192345) discloses a cryogenic process for the preparation of dry and fine spice powder. The method employs spraying liquid nitrogen over the material for 3 to 15 minutes and maintaining temperature of the cryogen between −20° C. to −60° C., the product is transferred to grinding mill and pulverized.

The Indian Patent Application No. 331/DEL/2002 (granted as IN222861) discloses an improved cryogenic method for producing of mixed spice powders and the process helps in higher retention of etheric oils and also prevention of oxidation and rancidity. The method involves injecting liquid nitrogen at the grinding zone containing raw materials; maintaining the temperature of cryogen between −20° C. to −60° C. and pulverizing under the controlled temperature.

India is located in a belt of sub-tropical and semi-arid to arid zones, such climatic conditions are conducive for the rapid growth of microorganisms and insects. The safety and quality of the food consumed by the general public is very important in the perspective of maintaining and enhancing general health. A new consciousness is growing all over the world about disease-causing organisms, poisonous substances and impurities. Parallel to this, the degree of excellence which consumers expect from foods is also growing. Exporting countries are thus constrained to maintain quality standards set by stringent food laws and regulations to ensure that foods including spices, are safe, wholesome and produced under sanitary and hygienic conditions.

Thus, there is an ever increasing need to develop newer and improved methods for preventing food spoilage. Embodiments of the present invention employ newer methods for preventing spoilage of food including spices.

### SUMMARY

An aspect of embodiments of the invention relates to a method for preparing microbial contamination free spice powder which retains the aroma, essential oils, taste, color, chemical compounds and antioxidant properties of the spice.

Another aspect of embodiments of the invention is to provide a microbial free and hygienic food product including spice, rice, nutritional bar or instant mix to the consumer.

Another aspect of embodiments of the invention is to provide cryogenically grinded spices which retains the aroma, essential oils, taste, color and chemical compound (Curcuminoids, Capsaicinoids, Piperine, etc.) of the product.

Another aspect of embodiments of the invention is to irradiate the food product including spice, rice, nutritional bar or instant mix to kill the microorganisms like coliforms, bacteria, fungi, yeast & molds, and larvae in the manufactured products.

Another aspect is to provide cryogenically grinded spices which have been irradiated to prevent oxidation.

Another aspect is to pack the spices with nitrogen purging to prevent spoilage of spices.

Another aspect is prevention of oxidation in grounded spice powders by using Gamma irradiation at 6-14 kGy post Cryogenic grinding.

Another aspect of embodiments of the present invention is to provide a method for grinding spices which involves Cryogenic conditions and Gamma irradiation.

Another aspect is recovery of specific chemical compounds and antioxidant activity with Cryogenic conditions and Gamma irradiation.

Accordingly, there is provided an improved method for preparing grinded spices which involves grinding under cryogenic conditions followed by gamma irradiation.

In one aspect of embodiments of the invention there is provided a method for preparing a microbial free spice powder which retains the aroma, essential oils, taste and color, chemical compounds and antioxidant properties of the spice, the method comprising the steps of:
a. Filling one or more dried raw spice into a feeding hopper,
b. Grinding the raw spice(s) under cryogenic conditions,
c. Packaging the ground powder obtained in step (b) first into primary packaging with nitrogen purging and then into secondary packaging,
d. Subjecting the packed spice powder to gamma irradiation and
e. Obtaining microbial free packed spice powder

In some embodiments of the invention the combination of cryogenic grinding and gamma irradiation are used to produce microbial free spice powder.

In some embodiments, the method is applicable for preparing Cryogenic spice powder selected from turmeric, pepper, chilli, coriander, rasam powder, garam masala, clove, cinnamon, cumin, cardamom and the like.

In some embodiments, the grinding under cryogenic conditions involves the following steps:
a. mixing the raw material with liquid nitrogen at temperature of 20 to 22° C.,
b. passing the mixture through hammer mill to obtain a coarse powder,
c. grinding the obtained coarse powder at universal mill under liquid nitrogen and at temperature of 5 to TC,
d. grinding the powder obtained in step c) at cryogenic mixer at temperature of −5 to 2° C. to obtain a fine powder, and
e. sieving the fine powder through rotary sifter.

In some embodiments, the method of the primary packaging is done in pouches with nitrogen purging and secondary packaging is done aseptically in cartons. In some embodiments, the material for primary packaging is selected from polyethylene terephthalate, metalized polyethylene terephthalate, polyethylene, polynatural, or biodegradable plastic or food grade plastic. In some embodiments, the secondary packaging is carried in 5 ply carton box.

In some embodiments, the method for preparing the spice powder provides the spice powder which is prevented from oxidation and rancidity. In some embodiments, the method for preparing the spice powder provide the spice powder which has extended shelf life due to prevention of oxidation process of volatile oils and chemical compounds and which is due to microbial elimination.

In some embodiments, the method employs subjecting packed Cryogenic spice powders to gamma irradiation of 240 kCi strength for 30-60 minutes. In some other embodiments, the source used for gamma irradiation is Cobalt 60.

### BRIEF DESCRIPTION

Some of the embodiments will be described in detail, with references to the following Figures, wherein like designations denote like members, wherein:

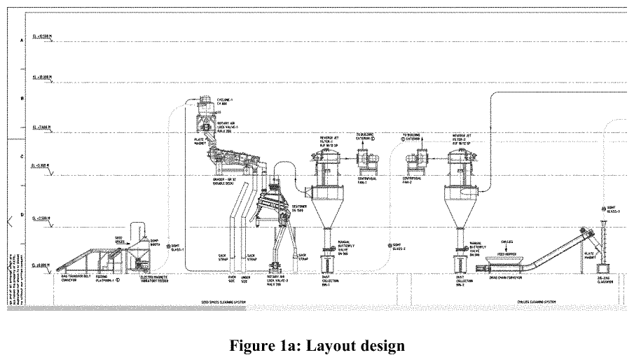

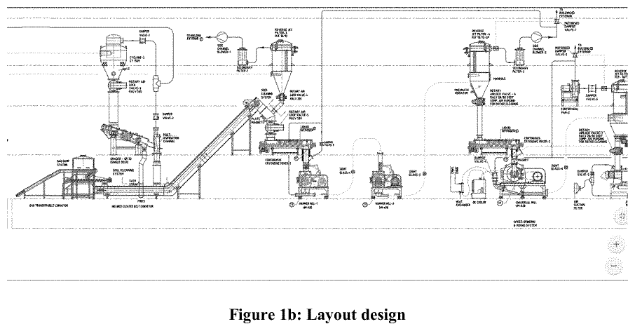

FIG. 1a, shows a layout design according to embodiments of the invention;

FIG. 1b shows a layout design according to embodiments of the invention;

FIG. 1c shows a layout design according to embodiments of the invention;

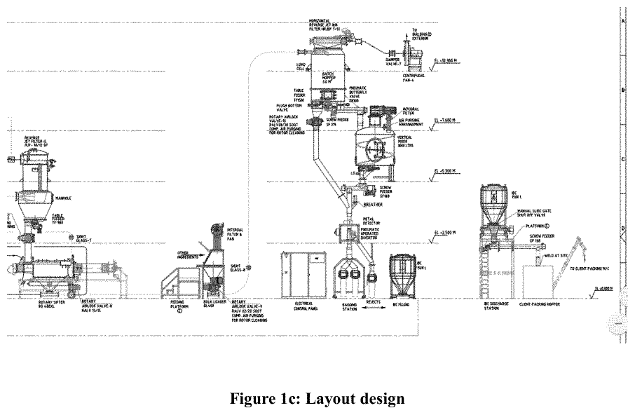

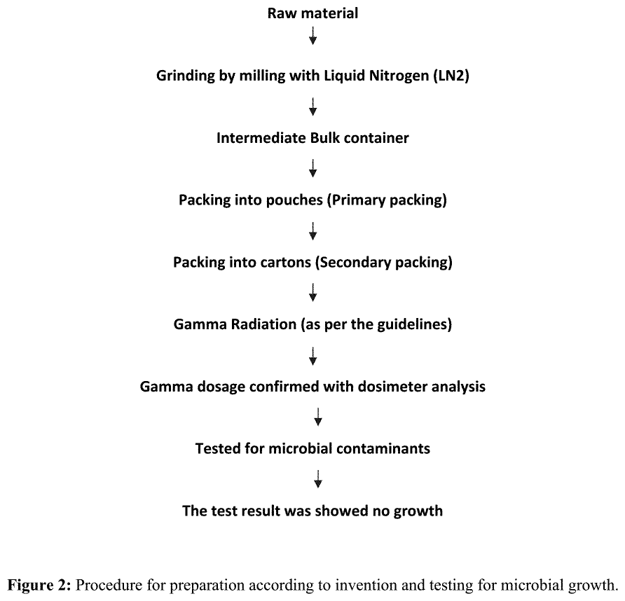

FIG. 2 shows a procedure for preparation according to embodiments of the invention including testing for microbial growth;

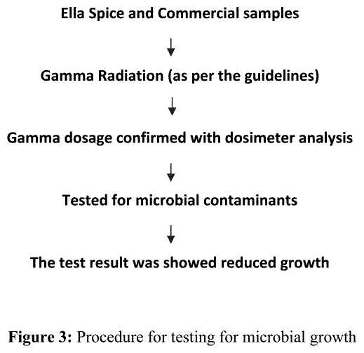

FIG. 3 shows a procedure for testing commercial samples for microbial growth according to embodiments of the invention;

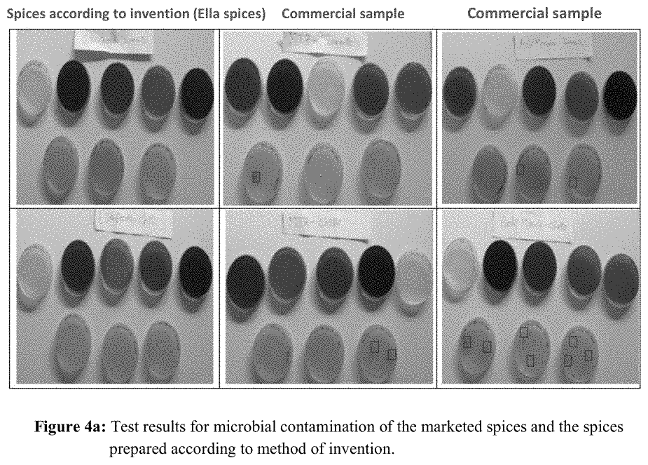

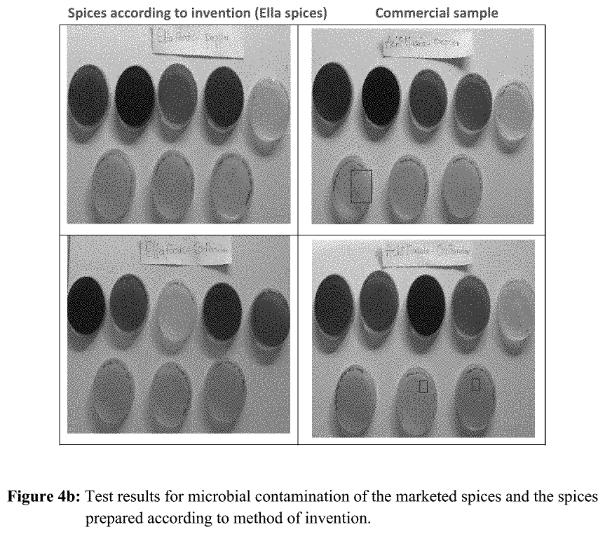

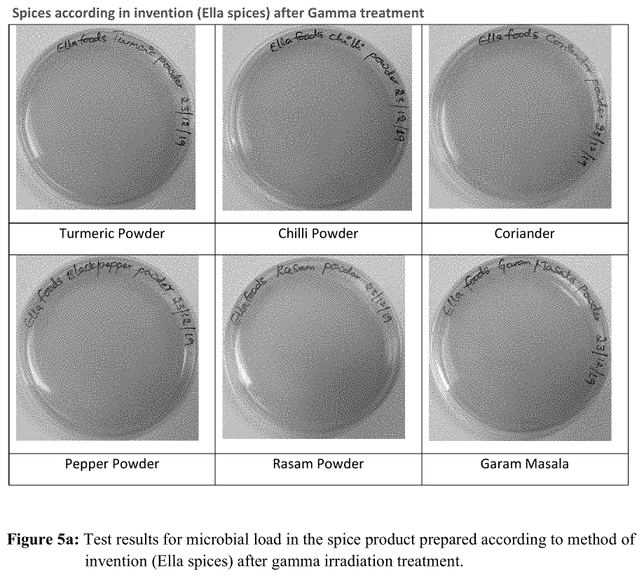

FIG. 4a shows test results for microbial contamination of the marketed spices and the spices prepared according to embodiments of the invention;

FIG. 4b shows test results for microbial contamination of the marketed spices and the spices prepared according to embodiments of the invention;

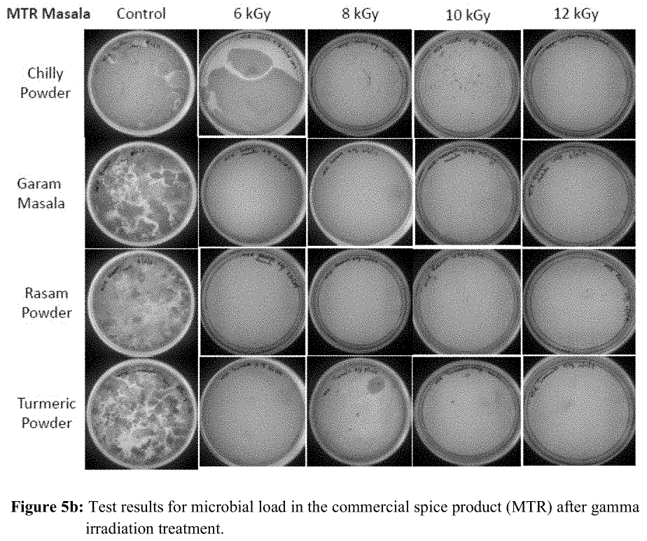

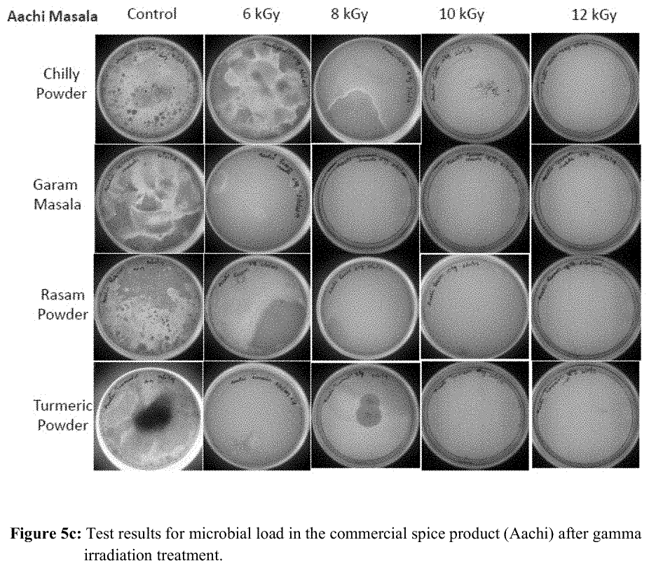

FIG. 5a shows test results for microbial load in the spice product prepared according to embodiments of the invention after gamma irradiation treatment;

FIG. 5b shows test results for microbial load in the commercial spice product after gamma irradiation treatment according to embodiments of the invention; and

FIG. 5c shows test results for microbial load in the commercial spice product after gamma irradiation treatment according to embodiments of the invention.

### DETAILED DESCRIPTION

Embodiments of the present invention are directed to providing cryogenically ground spices and cold pasteurized food products wherein aroma, flavor, essential oils, chemical compounds, taste of the spice has been maintained and the product is free of any microbial contamination.

In some embodiments, there is provided a hygienic food product including spice, rice, nutritional bar or instant mix to the consumer. In some embodiments, there is provided a method to irradiate the food product including spice, rice, nutritional bar, soup powders or instant mix to kill the microorganisms like coliforms, bacteria, fungi, yeast & molds, and larvae in the manufactured products. In some embodiments, there is provided a cryogenically ground spice which have been irradiated to prevent any further oxidation.

In one aspect of embodiments of the invention there is provided a method for preparing a microbe free spice powder which retains the aroma, essential oils, taste, color, chemical compounds and antioxidant properties of the spice, the method comprising the steps of:
a. Filling one or more dried raw spice into a feeding hopper,
b. Grinding the raw spice(s) under cryogenic conditions,
c. Packaging the ground powder obtained in step (b) first into primary packaging and then into secondary packaging,
d. Subjecting the packed spice powder to gamma irradiation, and
e. Obtaining microbial free packed spice powder.

In some embodiments, the combination of cryogenic grinding and gamma irradiation are used to produce microbial free spice powder. The cryogenic conditions during the grinding of the spices when combined with the gamma irradiation has provided significant reduction in microbial contamination.

In embodiments, the method improves the aroma/flavor retention of cryogenically ground spices. The claimed method retains the essential oils of the spices and increase the palatability of cryogenically grinded spices.

In some embodiments, the method is applicable for obtaining spice powder selected from turmeric, pepper, chilli, coriander, rasam powder, garam masala, clove, cinnamon, cumin, cardamom or the like.

In some embodiments, the method is also applicable to rice (black, red, unpolished and other varieties of rice), nutria bar, nutritional upma and other food products.

In some embodiments, the gamma irradiation method is used for reducing the microbial contamination. In some embodiments, the product categories which are subjected to gamma irradiation include herbs & spices, trail mix nuts, rice (red, black, unpolished rice) and nutritional bars.

In some embodiments, the grinding under cryogenic conditions involves the following steps:
a. mixing the raw material with liquid nitrogen at temperature of 20 to 22° C.,
b. passing the mixture through hammer mill to obtain a coarse powder,
c. grinding the obtained coarse powder at universal mill under liquid nitrogen and at temperature of 5 to 7° C.,
d. grinding the powder obtained in step c) at cryogenic mixer at temperature of −5 to 2° C. to obtain a fine powder, and
e. sieving the fine powder through rotary sifter.

In some embodiments, in the above described method the primary packaging is done in pouches with nitrogen purging and secondary packaging is done aseptically in cartons. In some embodiments, the material for primary packaging is selected from polyethylene terephthalate, metalized polyethylene terephthalate, polyethylene, polynatural, or biodegradable plastic or food grade plastic. In some embodiments, the secondary packaging is carried in 5 ply carton box.

In some embodiments, there is provided a process of nitrogen packaging of cryogenically ground spices and condiments. Nitrogen reduces the oxygen content within food packaging and hence prevents the product from deterioration. Thus, packaging with nitrogen gas is efficient, cost-effective way to displace oxygen and moisture. In some embodiments, the irradiation process and packaging of cryogenically ground spices/condiments are useful in retention of their sensory properties.

In some embodiments, microbial free sterile spice powder packed in fully sterile pouch retains volatile oil content and antioxidant properties. In some embodiments, the spice powder obtained according to the method has 20-30% additional recovery of volatile oils.

In some embodiments, the method for preparing the spice powder provides the spice powder which is prevented from oxidation and rancidity. In some embodiments, the method for preparing the spice powder provides the spice powder which has extended shelf life due to prevention of oxidation process of volatile oils and chemical compounds and due to microbial elimination.

In other embodiment, Gamma Irradiation at 6 to 14 kGy of Cryogenic ground powders retains 99% of the phenolic compounds and volatile oil of a Spice powder with full sterilization. Other sterilization techniques like fumigation or steam are heat based which reduces volatile oils and other chemical components and results in oxidation of spice powders. Prevention of oxidation in ground spice powders by using Gamma irradiation at 6-14 kGy post cryogenic grinding prevents microbial oxidation of essential oils and other chemical components.

In some embodiments, the method employs subjecting the packed spice powder to gamma irradiation of 240 kCi strength for 30-60 minutes. In some embodiment, the source used for gamma irradiation is Cobalt 60.

In embodiments, the method reduces the power consumption and specific energy compared to the ambient temperature grinding. Usually spices are contaminated with the microbial load and cryogenic spices having higher level of volatile oils, oleoresins and chemical compounds which is prone to spoil by microbes in the spices and oxidize the product. The gamma irradiation (cold pasteurization) reduces/kills the microbes which are present in spices and other food products.

In some embodiments, higher level of volatile oils oleoresins and chemical compounds recovery and protection of the same by 2nd stage Cryogenic grinding & Gamma irradiation respectively. Process improvement in extension of shelf life in spice powders, by prevention of oxidation process by microbial elimination using Gamma irradiation.

Embodiments of the invention also relate to cryogenic grinding and irradiation processing and packaging of food products including spices, rice, nutritional bar or instant mix food for retention of quality with easy serve in a hygienic wholesome way.

In an embodiment, the method is particularly advantageous in providing efficient size reduction, improved product flow, better retention of natural flavoring principles, free of microbial contamination and has large potential for commercial exploitation when compared to the conventional heat based methods.

### EXAMPLES

### Example 1: Procedure for Producing Cryogenic Grinding and Gamma Treated Spices

a. Cryogenic grinding: Raw material (RM) were dumped into the feed hopper/dump booth cleaning of RM in cyclone separator and graded in the grader. The RM was mixed with liquid nitrogen and was taken to the cryogenic mixture 1 and temperature maintained at 20 to 22° C. Air Coolers and Moisture separators ensure no heat and moisture add into the system aiding the prevention of any oxygen. Then the mixture was taken to the hammer mill and made into coarse powder. The coarse mixture was further taken to the cryogenic mixture and temperature maintained −5 to 2° C. Then the product was grounded as fine powder at universal mill and further passed through with rotary sifter for sieving and was stored in the batch hopper 1. Air Purging ensures no particles strand for any scope of oxidation. Then the product was mixed at vertical mixer and goes to batch hopper 2 and passed through the metal detector for metal particles and removed and discharged through internal bulk containers (IBC) or bulk bagging.

b. Packaging: The product from IBC was taken in to packing machine for the retail pouches (100 g, 200 g). The primary packing material was composed of 12 micron PET, 12 micron metalized PET and 90 micron poly natural and secondary packaging material was 5 ply carton box. Bulk bagging (1 to 25 kg) material was composed of Kraft paper 80GSM outer layer and inner layer composed of HDPE fabric mesh 10×10, HDPE Denier 860 and LDPE lamination 118G.

c. Gamma Irradiation: Packed finished cryogenic spice products and rice nutritional bar, instant mix etc., was taken for the gamma irradiation and the product was inspected at gamma center as packaging condition and batch/lot number. The product was labeled with Radura label and loaded in to the tote box and exposed for gamma irradiation.

Cobalt 60 was the source for gamma irradiation. Based on the source strength set the cycle time in the PLC for 6-14 kGy dose. Reference dosimeters were placed along with the product to know the absorbed dose. After completion of treatment dosimeters were evaluated.

Gamma Irradiation Source: Cobalt 60

Strength: 240 kCi

Time: 30 min

The Table 1 shows the comparison of physical parameters after traditional grinding and cryogenic grinding.

TABLE 1
Physical Parameters

| S. | | Ambient | Cryogenic |
|---|---|---|---|
| No | Parameter | grinding | grinding |
| 1 | Energy consumption | High | Low |
| 2 | Throughput | Low | High |
| 3 | Mill clogging | Frequent | No clogging |
| 4 | Volatile losses | Higher | Minimum |
| 5 | Grinding of soft material | Not possible | Possible |
| 6 | Control on particle size | No control | Effective |
| 7 | Fire risk | High | No risk |
| 8 | Microbial load | Possible | Does not exist |
| 9 | Colour of ground powder | Not original | Original |
| 10 | Prevention of oxidation | Low | High |
| | and rancidity | | |
| 11 | Power saving | low | High |

Table 2 shows the volatile oil content and Table 3 shows oleoresin after ambient grinding and after cryogenic grinding of various spices.

TABLE 2
Volatile oil Content

| | | Volatile Oil | | | |
|---|---|---|---|---|---|
| S. | Name of | Raw | Ambient | Cryogenic | % of |
| No. | the spice | Material | Grinding | Grinding | Recovery |
| 1 | Turmeric | 5.5 | 3.4 | 5.4 | 58.8 |
| 2 | Coriander | 0.6 | 0.4 | 0.6 | 50.0 |
| 3 | Chilli | 1.9 | 0.9 | 1.6 | 77.8 |
| 4 | Black Pepper | 3.4 | 2.5 | 3.0 | 20.0 |
| 5 | Garam Masala | 4.5 | 2.2 | 4.0 | 81.8 |
| 6 | Cardamom | 8.5 | 5.7 | 8.3 | 45.6 |
| 7 | Cloves | 17.0 | 11.9 | 16.6 | 39.5 |
| 8 | Cumin | 3.4 | 2.3 | 3.2 | 39.1 |
| 9 | Ajwain | 5.1 | 4.2 | 4.8 | 14.3 |
| 10 | Oregano | 3.2 | 2.6 | 3.0 | 15.4 |
| 11 | White Pepper | 3.3 | 2.2 | 3.1 | 40.9 |
| 12 | Mace | 15.0 | 9.3 | 14.2 | 52.7 |
| 13 | Piminto | 3.2 | 2.6 | 3.0 | 15.4 |

TABLE 3
Oleoresin Content

| | | Oleoresin | | | |
|---|---|---|---|---|---|
| S. | Name of | Raw | Ambient | Cryogenic | % of |
| No. | the spice | Material | Grinding | Grinding | Recovery |
| 1 | Turmeric | 15.0 | 10.1 | 13.3 | 31.7 |
| 2 | Coriander | 20.0 | 11.1 | 18.5 | 66.7 |
| 3 | Pepper | 12.8 | 7.7 | 9.4 | 22.1 |
| 4 | Fenugreek | 8.0 | 4.6 | 5.5 | 19.6 |
| 5 | Cumin | 18.0 | 11.6 | 15.0 | 29.3 |
| 6 | Ajwain | 25.0 | 19.9 | 23.0 | 15.6 |

Table 4 shows the antioxidant activity after ambient grinding and after cryogenic grinding of various spices.

TABLE 4
Antioxidant Activity

| | | Antioxidant activity | | | | | | | |
|---|---|---|---|---|---|---|---|---|---|
| | | Total Phenolic Content | | Total Flavonoids C | | Antioxidant content | | | |
| | | (mg GAE) | | (mg QE) | | (mg BHT E) | | Scavenging % | |
| S. | Name of | Ambient | Cryogenic | Ambient | Cryogenic | Ambient | Cryogenic | Ambient | Cryogenic |
| No. | the spice | Grinding | Grinding | Grinding | Grinding | Grinding | Grinding | Grinding | Grinding |
| 1 | Turmeric | 1.6 | 2.1 | 15.1 | 28.0 | 0.5 | 1.3 | 78.0 | 81.8 |
| 2 | Coriander | 0.8 | 1.0 | 6.9 | 12.1 | 0.4 | 0.8 | 39.0 | 89.5 |
| 3 | Cumin | 99.0 | 110.5 | 27.1 | 39.4 | 6.5 | 8.8 | 18.9 | 23.5 |
| 4 | Fenugreek | 4..5 | 5.7 | 69.0 | 79.3 | 6.0 | 10.0 | 48.5 | 80.7 |
| 5 | Ajwain | 75.3 | 115.0 | 343.0 | 523.0 | 133.2 | 145.2 | 48.0 | 94.5 |

Table 5 shows chemical Compound Recovery after ambient grinding and after cryogenic grinding of various spices.

TABLE 5
Chemical Compound Recovery
Spice Chemical compound Recovery Ambient and Cryogenic grinding

| S. | | | Ambient | Cryogenic | Recovery |
|---|---|---|---|---|---|
| No. | Spice Name | Parameter | g/100 g | | % |
| 1 | Chilli | Capsaicinoids | 0.26 | 0.29 | 11.5 |
| 2 | Turmeric | Curcuminoids | 4.4 | 6..0 | 36.3 |
| 3 | Black Pepper | Piperine | 5.0 | 6.2 | 24.0 |

### Example 2: Effect of Gamma Irradiation on Cryogenic Grinded Spices

The cryogenically ground spices as prepared according to method described in Example 1 were tested before and after gamma irradiation for microbial contamination and results have been shown in Table 6.

TABLE 6
Microbial Content of Foods Spices Before and after Gamma Treatment
Microbial Parameters
Spices Before and after Gamma Treatment

| S. | | Before Gamma | | | | After Gamma | | | |
|---|---|---|---|---|---|---|---|---|---|
| No. | Parameters | Chilli | Coriander | Pepper | Turmeric | Chilli | Coriander | Pepper | Turmeric |
| 1 | Total Plate | 573 | 530 | 2400 | 796 | 0 | 0 | 0 | 0 |
| | count, cfu/g | | | | | | | | |
| 2 | Yeast and Mould | 320 | 1012 | 100 | 0 | 0 | 0 | 0 | 0 |
| | count, cfu/g | | | | | | | | |
| 3 | E. Coli, cfu/g | 4 | 3 | 1 | 3 | 0 | 0 | 0 | 0 |
| 4 | Pseudomonas | 0 | 0 | 0 | 0 | 0 | 0 | 0 | 0 |
| | spp,/g | | | | | | | | |
| 5 | Staphylococuus | 0 | 3 | 0 | 0 | 0 | 0 | 0 | 0 |
| | Aureus | | | | | | | | |
| 6 | Salmonella spp, | Abs | Abs | Abs | Abs | Abs | Abs | Abs | Abs |
| | cfu/25g | | | | | | | | |
| 7 | Aspergillus spp, | 1080 | 15 | 30 | 110 | 0 | 0 | 0 | 0 |
| | cfu/g | | | | | | | | |

As can be seen from the results of the above given Table 6, for the cryogenic ground spices there was significant decrease in microbial contamination after gamma irradiation.

EXAMPLE 3: Evaluation of microbial contamination for spices prepared according to embodiments of the invention (cryogenic grinding and gamma irradiation) and the marketed spices after gamma irradiation:

Usually spices and its products contains microbial contaminants. We tested the spice samples (cryogenic ground according to embodiments of the invention and marketed spice samples) after gamma irradiation treatment for microbial contaminants. The protocol followed for the spices prepared according to embodiments of the invention involving both cryogenic grinding and gamma irradiation were according to process flow diagram given in FIG. 2 and for marketed samples according to process flow diagram in FIG. 3.

Finished product of spice powder samples were opened in sterile condition under biosafety cabinet and weighed one gram of sample in eppendorf. Then aliquoted 10 ml of normal saline in the test tubes, and added the one gram of sample into the tube. Mixed the sample with sterile tip and vortex and leave to settle. Labeled the media plates and then took 100 μl of sample and added into the media plate. Then by using sterile L rods spread on the media, incubated the media plates in the calibrated 35° C. incubator for 48 hours for bacterial pathogens and 25° C. incubator for 3 to 5 days for fungal and other pathogens. Observed the plates and recorded the growth.

Tested for pathogens—E. coli, coliform, Staphylococcus aureus, Pseudomonas aeruginosa, Salmonella spp, Aspergillus spp, yeast and molds.

1. Staphylococcus spp—Mannitol salt agar

2. Pseudomonas spp—Cetrimide agar

3. E. coli—MacConkey agar

4. Coliform—Eosin methylene blue agar

5. Salmonella spp—Xylose lysine deoxycholate agar

6. Yeast molds & Aspergillus spp—Sabouraud dextrose agar

The results obtained have been shown in FIGS. 4a, 4b, 5a, 5b, and 5c. It was found that the microbial contaminates were reduced in the market samples, however no contaminants were observed in the spices prepared according to embodiments of the invention. The study showed the way to reduce the microbial load and prevention of oxidation in the products.

Although the invention has been illustrated and described in greater detail with reference to the preferred exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for preparing microbial contamination free spice powder which retains aroma, essential oils, taste, color, chemical compounds, and antioxidant properties, the method comprising:
a. filling one or more dried raw spice into a feeding hopper;
b. grinding the one or more dried raw spice under cryogenic conditions;
c. packaging the powder obtained in step (b) first into primary packaging and then into secondary packaging;
d. subjecting the packed spice powder to gamma irradiation; and
e. obtaining microbial contamination free packed spice powder.

2. The method as claimed in claim 1, wherein combination of cryogenic grinding and gamma irradiation is used to produce the microbial contamination free spice powder.

3. The method as claimed in the claim 1, wherein the one or more dried raw spice is selected from turmeric, pepper, chilli, coriander, rasam powder, garam masala, clove, cinnamon, cumin, and cardamom.

4. The method as claimed in claim 1, wherein the step (b) of grinding under cryogenic conditions involves the following:
a. mixing raw material with liquid nitrogen at a temperature of 20 to 22° C.;
b. passing the mixture through a hammer mill to obtain a coarse powder;
c. grinding the obtained coarse powder at a universal mill under liquid nitrogen and at a temperature of 5 to 7° C.;
d. grinding the powder obtained in step c) at cryogenic mixer at a temperature of −5 to 2° C. to obtain a fine powder; and
e. sieving the fine powder through a rotary sifter.

5. The method as claimed in claim 1, wherein the primary packaging is done in pouches with nitrogen purging and secondary packaging is done aseptically in cartons.

6. The method as claimed in claim 1, wherein the material for primary packaging is selected from polyethylene terephthalate, metalized polyethylene terephthalate, polyethylene, polynatural, or biodegradable plastic or food grade plastic.

7. The method as claimed in claim 1, wherein the secondary packaging is carried in 5 ply carton box.

8. The method as claimed in claim 1, wherein the packaging of the ground powder is carried with nitrogen gas.

9. The method as claimed in claim 1, wherein the microbial contamination free packed spice powder obtained is prevented from oxidation and rancidity.

10. The method as claimed in claim 1, wherein the microbial contamination free packed spice powder obtained has extended shelf life due to prevention of oxidation process of volatile oils and chemical compounds and due to microbial elimination.

11. The method as claimed in claim 1, wherein the packed spice powder is subjected to gamma irradiation of 240 kCi strength for 30-60 minutes.

12. The method as claimed in claim 11, wherein Cobalt 60 is used as a source for gamma irradiation.

13. A method for preparing microbial contamination free spice powder which retains aroma, essential oils, taste, color, chemical compounds and antioxidant properties, the method comprising:
f. filling one or more dried raw spice into a feeding hopper;
g. grinding the one or more dried raw spice under cryogenic conditions;
h. packaging the ground powder obtained in step (b) first into primary packaging and then into secondary packaging;
i. subjecting the packed spice powder to gamma irradiation;
j. subjecting packed rice, nutria bar, and/or instant mixes to gamma irradiation; and
k. obtaining microbial contamination free packed spice powder and packed rice, nutria bar, and/or instant mixes.
